(19) United States
(12) Patent Application Publication
(10) Pub. No.: US 2026/0151282 A1
(43) Pub. Date: Jun. 4, 2026

(54) Anti-slip device for therapeutic cushion and method for manufacturing the same

(71) Applicant: AMYLIOR INC., Vaudreuil-Dorion (CA)

(72) Inventors: Jean-Luc Lessard, Sherbrooke (CA); Jerry Houtart, Quebec (CA); Willem Dugas, Ile-Perrot (CA); Peter Hajj, Sherbrooke (CA)

(21) Appl. No.: 19/407,148

(22) Filed: Dec. 3, 2025

Related U.S. Application Data
(60) Provisional application No. 63/727,399, filed on Dec. 3, 2024.

(51) Int. Cl. A61G 5/10

(52) U.S. Cl. CPC A61G 5/1091

(57) ABSTRACT

An anti-slip cushion or cover is provided. The anti-slip cushion or cover may be made of a two-way or four-way stretch material. The cushion or cover further comprises a thin layer of friction or anti-slip material. This anti-slip surface may comprise a substrate such as a silicone or urethane on the fabric typically by, but not limited to, a silk screen process. The friction layer may comprise different patterns allowing increased stretchability in specific areas based on therapeutic needs.

### CROSS-REFERENCE TO RELATED APPLICATIONS

The present patent application claims the benefits of priority of United States Provisional Patent Application No. 63/727,399, entitled “ANTI SLIP DEVICE FOR THERAPEUTIC CUSHION AND METHOD FOR MANUFACTURING THE SAME”, and filed at the United States Patent and Trademark Office on December 3^{rd}, 2024, the content of which is incorporated herein by reference.

### FIELD OF THE INVENTION

The present invention generally relates to wheelchair cushions and methods for manufacturing wheelchair cushions. More specifically, the present invention relates to therapeutic wheelchair cushions having anti-slip properties and methods for manufacturing the said wheelchair cushions.

### BACKGROUND OF THE INVENTION

Slipping in the anterior - posterior plane is a regular occurrence for wheelchair users. This can lead to a poor musculoskeletal position and increased pressure ulcer risk. To prevent this, many wheelchairs cushion manufacturers use anti thrust wedges, blocks or other mechanical stoppers. An abductor can be used to stabilize the sitting person from sliding as shown in patents US 6,625,830 B2 and US 9,635,897 B2. These have some success in preventing slip, but the discomfort and the risk of forming high pressure points are significant. Another technique is the use of anti-slip material on the top of the cushion cover. Typical materials used to do so are neoprene, urethane or any materials that have a high coefficient of friction. The material can cover the whole seat or part of it. Having the high friction material in the rear section (gluteal- ischium zone) has the maximum efficiency because it is typically where you also have the maximum load. Since the retaining force is a product of the load on cushion and the friction coefficient, the slip mitigation is good. The counterpart is that the retaining force also produces a shear force at a critical, high-risk zone, namely the ischium / sacrum area. Furthermore, the material used is typically a non-breathable fabric that leads to retain moisture in this zone which is another key factor in increasing the risk of pressure ulcer formation.

Being in a seated position for an extended period in a wheelchair where vibrations and bumps take place while riding can lead to the patient slipping into an antero-posterior slip. Furthermore, the prolonged sitting is a contributing factor to the formation of pressure ulcers. There is thus a need for an improved therapeutic cushion providing a surface that helps to keep the user in a proper seated position while minimizing the influence of this non-slip surface on the cushion’s ability to prevent pressure ulcers.

### SUMMARY OF THE INVENTION

The shortcomings of the prior art are generally mitigated by an anti-slip cover using a two or four way stretch material on the top of the cushion. Two way stretch means that it stretches significantly more in a first direction of the woven material compared to a second direction. The first and second directions may be preferably perpendicular. Four way stretch means that the material stretches equally or substantially equally in both first and second directions of the woven material. The material used is also typically low friction and breathable. In some aspects of the invention, using a two way stretch fabric, the low stretch direction of the fabric is preferably placed in the anterior-posterior axis direction while the higher stretch direction is positioned in the transverse axis direction.

Friction is needed to prevent a user from slipping. As such, a layer of high friction material may be applied on the surface or partially over the surface of the fabric with specific criteria. The high friction material may be embodied as a high friction silicone applied by a silk screen process and cured on the surface. The added layer is relatively thin and typically within 1mm.

The high friction layer specifically aims at avoiding the ischium / sacrum area to allow movement in this area. The high friction layer generally covers the buttock without going under the ischium /sacrum area. In some aspects of the invention, the high friction layer can be applied to allow a certain percentage of fill, such as but not limited to between 20% to 90 % of the overall contour surface to get a good overall friction force. In some aspects of the invention, the pattern can be designed from a fully filled surface of high-friction substrate with repeated omitted high-friction substrate or non covered shapes (negative), or a geometrical pattern of the high-friction substrate that fills the otherwise empty surface contour (positive).

When using a 4-way stretch in either method (positive or negative pattern), the pattern of the omitted or non-covered surface or the repeated shape shall be oriented so that the addition of friction material generally aims at minimally influencing the level of stretch of the cover’s contact surface material in the transverse direction. The pattern may contribute to making the cover contact surface material stiffer in the anterior-posterior axis, thus generally helping to retain the patient in a proper position. When using a 2 way stretch fabric, the pattern of the omitted surface or non covered surface or the repeated shape shall be isotropic, to keep the fabric relative stretch properties unchanged, or oriented to enhance the relative stretch properties. The high friction material elongation ability should be equal or superior to the support fabric in order to avoid damage to the anti-slip surface.

In one aspect of the invention, an anti-slip cover for a therapeutic cushion of a wheelchair is provided. The anti-slip cover comprises a base layer configured to cover the therapeutic cushion, the base layer having directional stretching properties and a layer of flexible anti-slip material affixed over the base layer and forming patterns configured to retain buttock of a user in a proper therapeutic position, wherein the formed pattern comprises a low friction area positioned to receive ischium/sacrum of the user, an area positioned to receive gluteal portion of the user, the gluteal area having a friction coefficient higher than a friction coefficient of the ischium/sacrum area and an area to receive thigh portion of the user having a friction coefficient higher than the friction coefficient of the ischium/sacrum area.

The anti-slip layer may form an opened portion exposing the base layer to receive a rear portion of the buttocks of the user. The opened portion may have an angle varying between 5 to 10 degrees about a vertical axis.

The area to receive thigh portion of the user may have a friction coefficient higher than the friction coefficient of the gluteal area. The anti-slip cover may stretch along two different axes or directions. The two different axes or directions may be orthogonal. The cover may have higher stretching properties along a first of the two stretching axes or directions than along a second of the two stretching axes or directions.

The layer of anti-slip material may be coated to the base layer. The layer of anti-slip material may be made of silicone or urethane. The base layer may be made of low friction and breathable fabric. The formed patterns of the anti-slip layer may comprise shapes exposing the base layer. The patterns may be shaped as any one of elliptical, diamond, dot, lozenges or curvilinear shapes. The formed patterns may comprise shapes of anti-slip material over the base layer. The layer of anti-slip material may cover less than 100% of the base layer. The layer of anti-slip material may cover between 20% and 90% of the base layer.

In another aspect of the invention, a method for manufacturing an anti-slip cover for a therapeutic cushion is provided. The method comprises having a base layer shaped to be received by a top portion of the therapeutic cushion, the base layer having directional stretching properties; and coating a layer made of anti-slip and semi-rigid material on the base layer to form ant-slip patterns configured to retain buttock of a user in a proper therapeutic position.

The creation of pattern of the anti-slip material may be performed using a silk screen process.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1A is a side elevation view of an exemplary skeleton of a person sitting in a normal position.

FIG. 1B is a rear elevation view of the exemplary skeleton of FIG. 1A.

FIG. 2 is a side elevation view of an exemplary skeleton of a person sitting in a posterior tilt position.

FIG. 3 is a rear elevation view of an exemplary skeleton of a person sitting on a profiled cushion surface with a contact surface of the person with the cushion highlighted in white and with the typical bony prominence at risk of pressure ulcer.

FIG. 4A is a top plan view of an embodiment of a cushion cover in accordance with the principles of the present invention, shown with a 2-way stretch, breathable fabric with a preferable oriented stretch direction illustrated by the magnitude of the red arrows.

FIG. 4B is a top plan view of an embodiment of a cushion cover in accordance with the principles of the present invention, shown with a 4-way stretch, breathable fabric.

FIG. 5 is a top plan view of an embodiment of the cushion cover of FIG. 4A shown with a grayed section representing the area where the top cover comprises an anti-slip coating at 100% coverage and where the white section is the ischium / sacrum area where the properties of the base material remain unchanged.

FIG. 6 is a top plan view of the cushion cover of FIG. 4A shown with a grayed section representing the area where the top cover comprises an anti-slip coating at 75% coverage having negative (non-covered) diamond pattern and with a white section, including the ischium / sacrum area, having no anti-slip properties to preserve the base material properties.

FIG. 7 is a top plan view of the cushion cover of FIG. 4A shown with a grayed section representing the area where the top cover comprises an anti-slip coating or layer being a 100% anti-slip coverage in the thigh section and a coverage of about 75% of the cover at the gluteal section has by using a negative diamond pattern and with a white section, including the ischium / sacrum area without anti-slip coating to preserve the base material properties.

FIG. 8 is a top plan view of the cushion cover of FIG. 4A shown with a grayed section representing the area where the top of the cover comprises an anti-slip coating having a thigh section with 100% anti-slip coverage and a gluteal section with 75% anti-slip coverage by using a negative diamond pattern and with a white section, including the ischium / sacrum area are kept without anti-slip coating to preserve the base material properties. Left and right sections are not connected together.

FIG. 9 is a top plan view of the cushion cover of FIG. 4A shown with a grayed section representing the area where the top surface of the cover received an anti-slip coating having a 66% coverage by using a negative oriented elliptical pattern and with a white section at least covering the ischium / sacrum area of the user without anti-slip coating.

FIG. 10 is a top plan view of the cushion cover of FIG. 4A shown with a grayed section representing an area comprising an anti-slip coating having a 66% coverage by using a negative non oriented dot pattern and with a white section at least covering the ischium / sacrum area and being without anti-slip coating.

FIG. 11 is a top plan view of the cushion cover of FIG. 4A shown with a grayed section comprising an anti-slip coating having about 25% coverage by using a positive curvilinear pattern and with a white section at least covering under the ischium / sacrum area of the user without anti-slip coating

FIG. 12 is a top plan view of the cushion cover of FIG. 4A shown with a grayed section comprising an anti-slip coating having about 75% coverage by using a negative diamond pattern and with a white section at least covering under the ischium / sacrum area of the user without anti-slip coating. The global pattern of the anti-slip being symmetrical in both direction.

FIG. 13 is a top plan view of the cover of FIG. 4A shown with anti-slip areas positioned to receive the gluteal and thigh portions of the user and free of anti-slip material at the rear of the buttock and under the ischium/sacrum portion of the user.

FIG. 14 is a top plan view of the cushion cover of FIG. 4A shown with a grayed section representing an anti-slip layer having a coverage of about two third of the cover and having an opened portion for receiving a rear portion of the buttock of the user.

### DETAILED DESCRIPTION OF THE INVENTION

A novel anti-slip device for therapeutic cushion will be described hereinafter. Although the invention is described in terms of specific illustrative embodiments, it is to be understood that the embodiments described herein are by way of example only and that the scope of the invention is not intended to be limited thereby.

The present invention provides an anti-slip cushion cover using a two-way or four-way stretch material on top of a cushion in combination with an anti-slip surface, coating or layer added to the cover. This anti-slip surface is achieved by adding a substrate such as a silicone or urethane on the fabric typically by, but not limited to, a silk screen process.

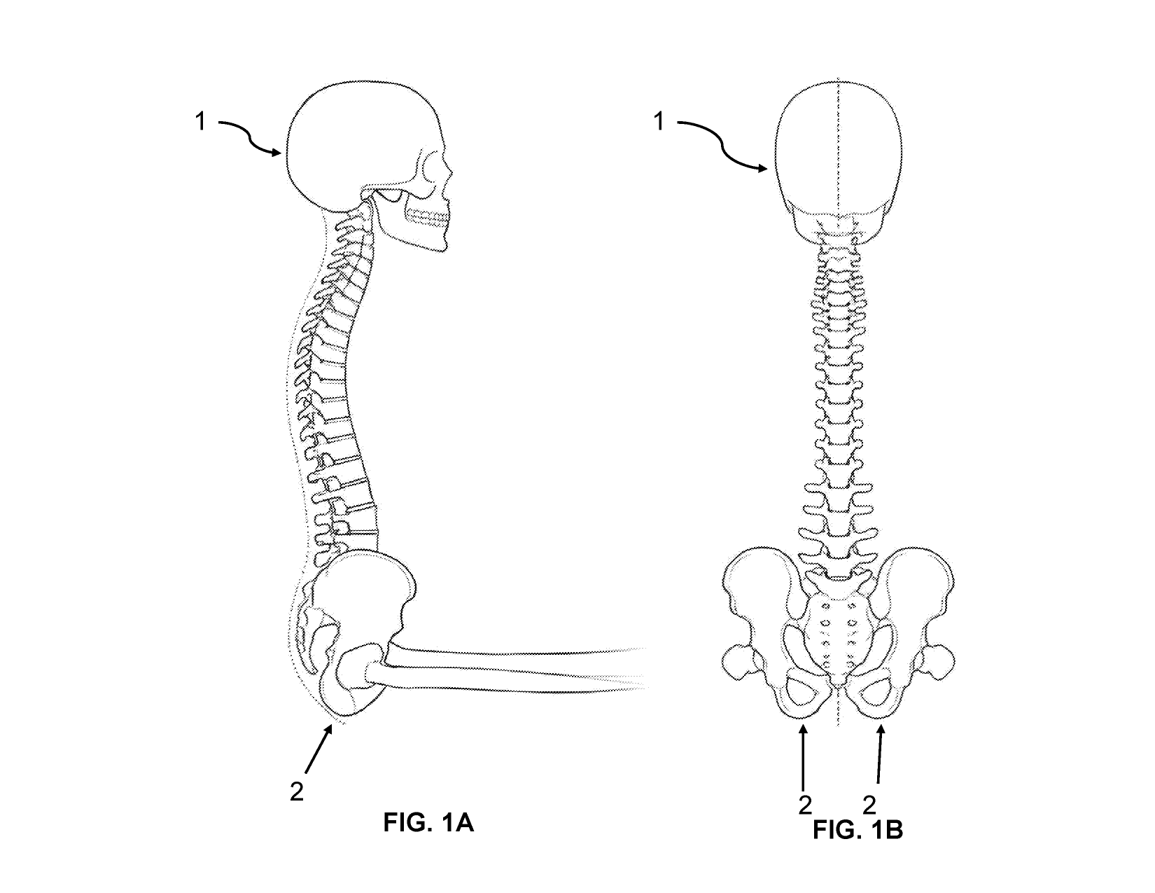

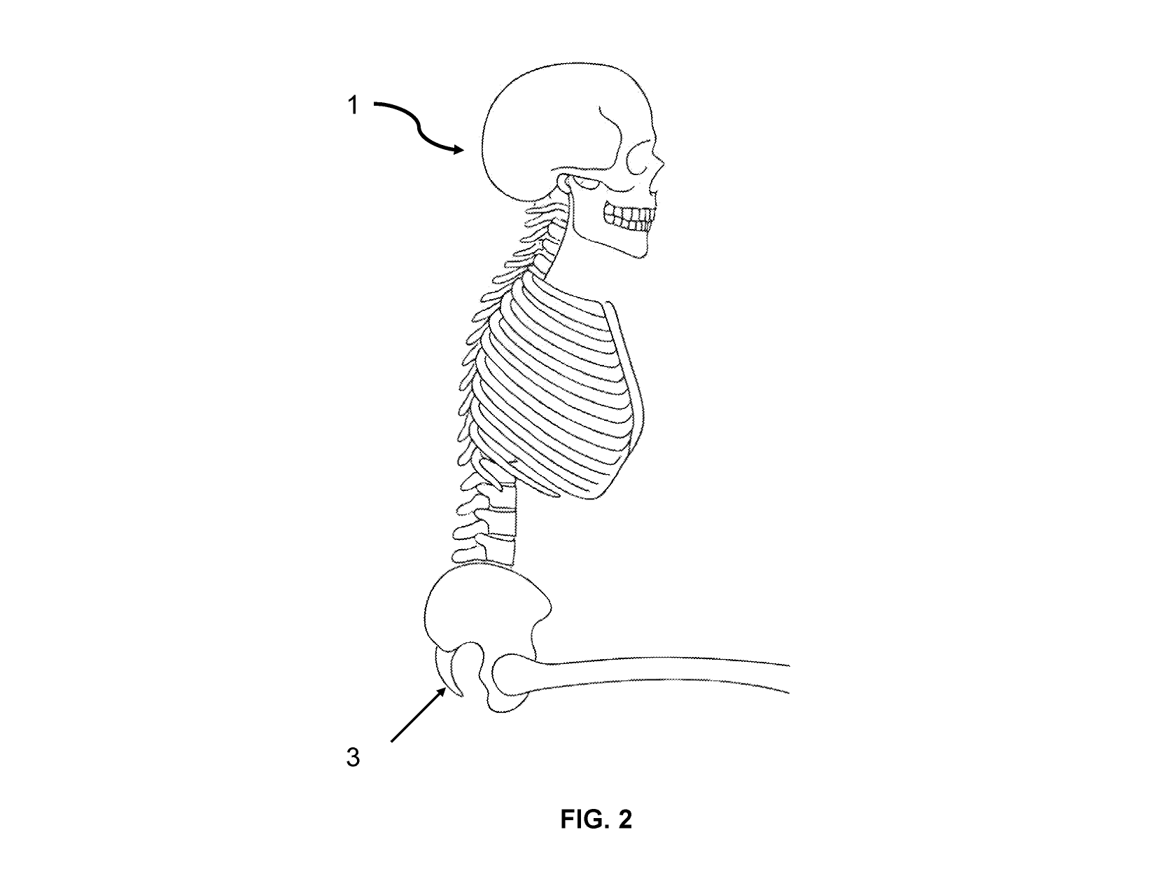

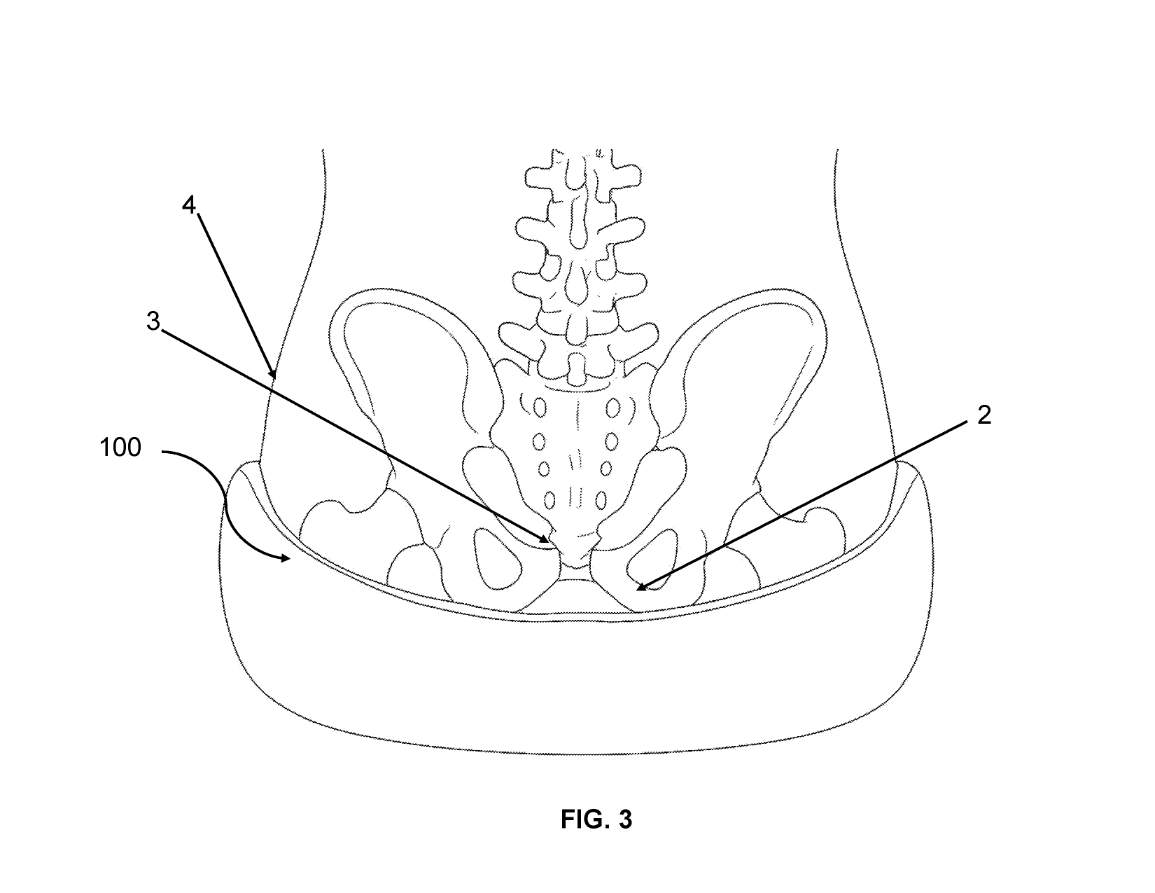

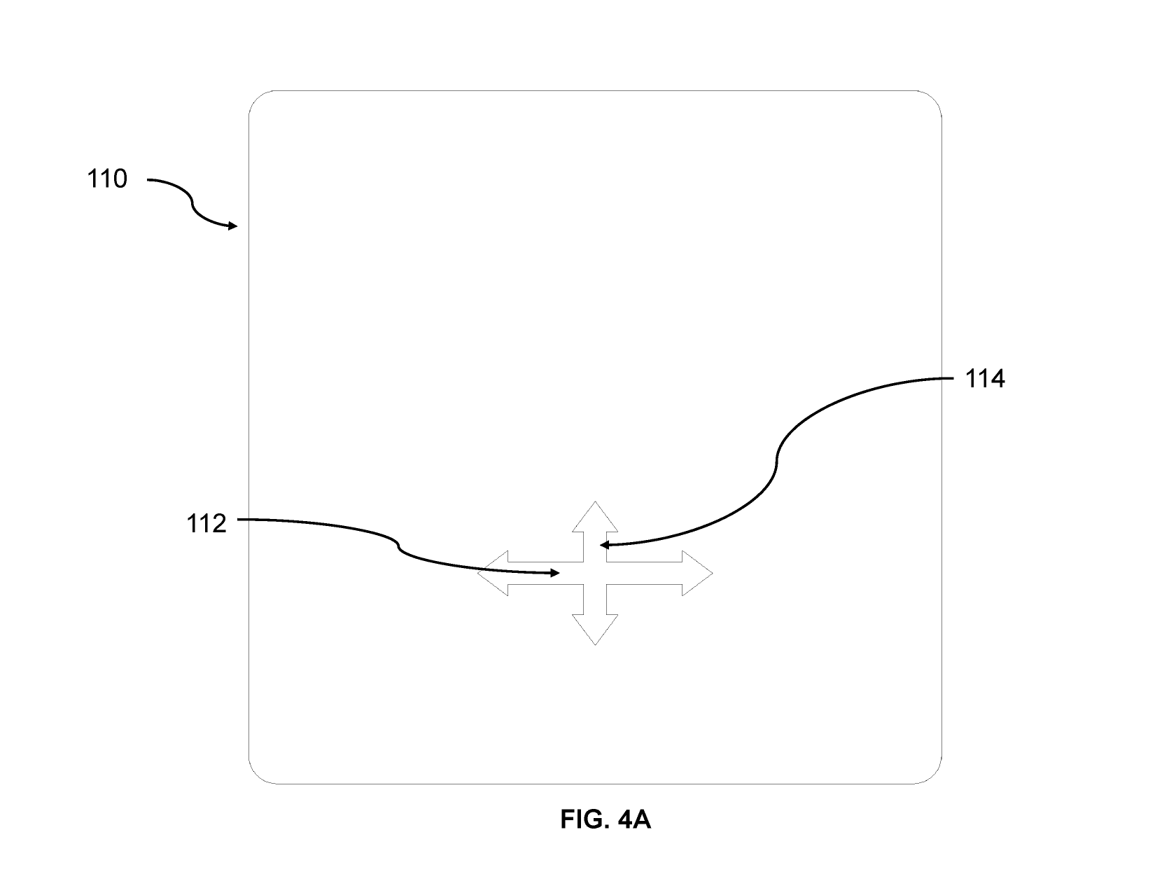

The location of the anti-slip substrate is particularly important to provide the anti-slip performance while avoiding increasing the risk of pressure ulcer formation. Referring now to FIG. 1, an exemplary skeleton of a user shown in a sitting position is illustrated. More particularly, the region under the ischium bone 2 is illustrated. Such region 2 of a patient 1 is a typical zone where the risk is high when a patient 1 is in a sitting position. Now referring to FIG. 2, the skeleton 1 of FIG. 1 is shown sitting in a posterior tilt position, the sacral bone 3 of the patient 1 can also be at high risk. Referring now to FIG. 3, a buttock 4 of a patient 1 is shown sitting on an embodiment of a cushion 100.

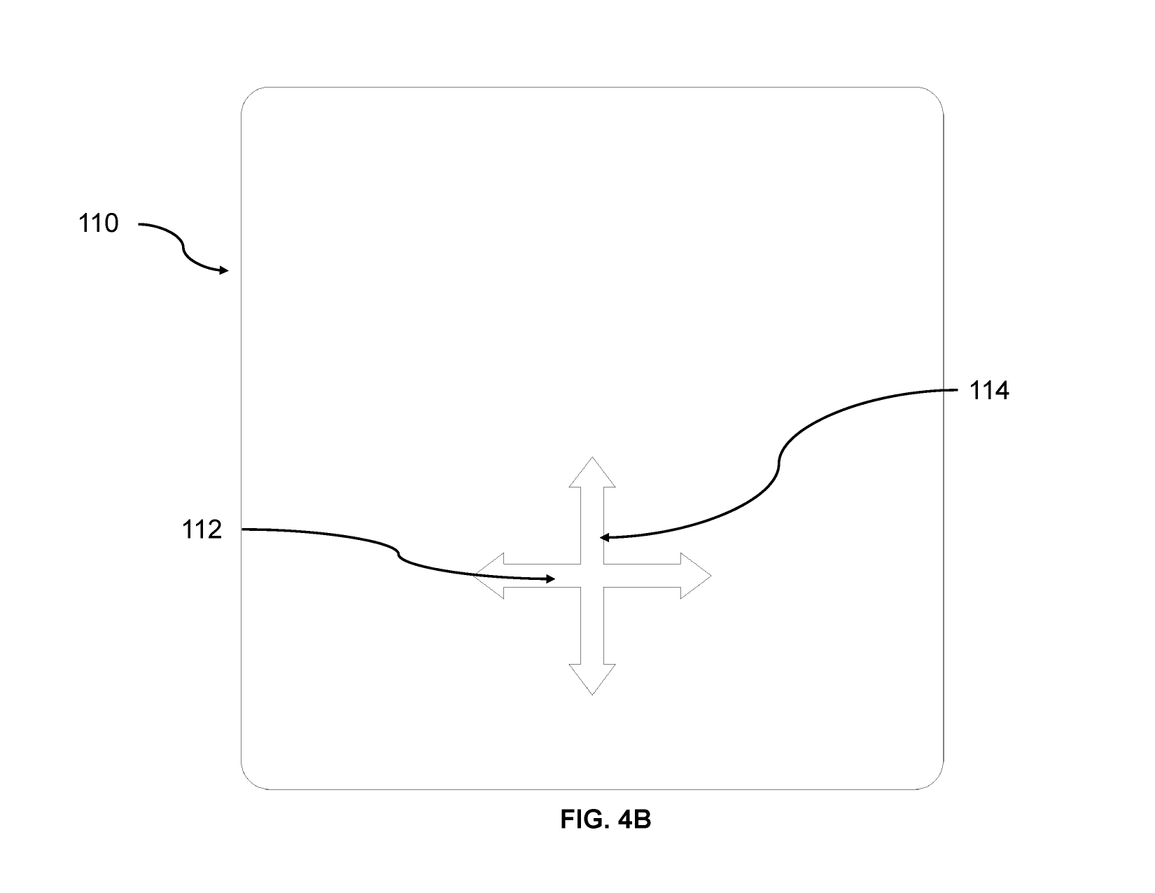

Referring now to FIGS. 4A and 4B, an embodied of a cover 110 of a cushion 100 is illustrated. The cover 110 is made of material having stretching properties which varies depending on two directions of the stretching. In the embodiments illustrated at FIGS. 4A and 4B, the first stretching direction 112 is perpendicular to the second stretching direction 114. In the embodiment of FIG. 4A, the first direction 112 has higher stretching properties than the second direction 114. In the embodiment of FIG. 4B, the first direction 112 has stretching properties which are substantially equal to the stretching properties of the second direction 114. The stretching properties of the top of the cover 110 are generally important to avoid creation of a hammock effect. A hammock effect generally increases the pressure at the most critical zones under the buttock of the patient, typically under the bony prominences, because of immersion being limited by the surface tension of the cover 110 (see FIG. 3).

In order to provide stretching properties and to avoid the hammock effect while preventing the migration of the position in the anterior-posterior direction (slipping), a two-way or four-way stretch fabric is used. Two-way stretch fabric means that the fabric stretches significantly more in one direction 112 of the woven material as shown in FIG. 4A.

A four-way stretch fabric, as shown at FIG. 4B, generally means that the fabric stretches substantially equally in the first 112 and second 114 directions. The cover is typically made of a material having low friction and being breathable. Having a breathable and low friction fabric generally aims at reducing pressure ulcer risk by mitigating shear forces and reducing moisture accumulation from sweat. In some embodiments of the present invention, the lower stretch direction of the fabric, if any, is located in the anterior-posterior axis direction to limit the positional migration. The higher stretch direction may further be located in the transverse axis direction to prevent a hammock effect.

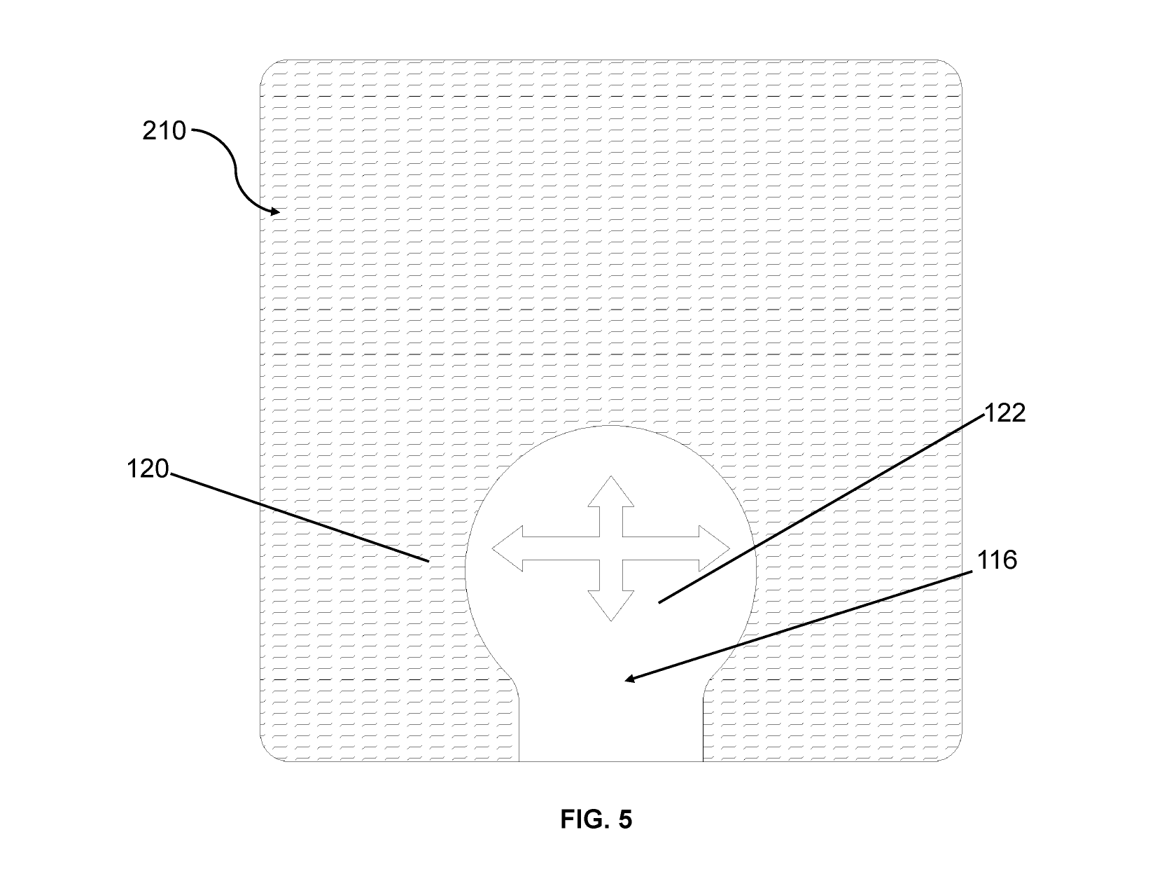

Referring now to FIG. 5, as friction is required to prevent slipping, a high friction or anti-slip layer 120 is superposed to the surface of the fabric 110 with specific criteria. Broadly, the anti-slip layer 120 is applied to the fabric not cover or to surround the ischium/sacrum area of a patient or user. The patterns of the anti-slip layer 120 may further be oriented to stay aligned with the movement of the two-way or four-way stretch fabric. Furthermore, the anti-slip layer 120 may generally cover the buttock region of the user or patient around the ischium, all the way to the middle of the thigh. The anti-slip layer 120 is typically made of high-friction yet flexible material which may be applied to the fabric layer 110. The anti-slip layer 120 may have some stretching properties to allow extending with the fabric layer 110. In some embodiments, the anti-slip layer 120 may be a high friction silicone applied using a silk screen process and cured on the surface of the fabric 110. In preferred embodiments, the anti-slip layer is typically very thin, such as but not limited as having a thickness of less than 1 mm. The anti-slip layer 120 generally aims at ensuring a uniform skin perception between the regions of the cover 110 coated with the high-friction substrate or layer 120 and those regions which have nothing applied.

Still referring to FIG. 5, The cover 210 may comprise regions being uncoated or without a friction layer 122, such as including only the bare fabric material in such regions 122, and regions comprising an anti-slip layer 120. The area of the cover under the ischium / sacrum area of the user 116 is typically not be covered with a friction layer 120, as shown in FIG. 5. As such, the area of the cover 210 coated or covered with the anti-slip layer 120 preferably extends under the buttock of the user without going under the ischium /sacrum area of the user. The anti-slip layer 120 may be 100% opaque or, in other words fully recovers the base surface 122, as shown at FIG. 5. A fully opaque anti-slip layer 120 provides maximum adhesion for the received body portion of the patient 1. The proportion of coated area 120 versus the non-coated area 122 affects the overall stretchability of the cover, namely in the first 112 and second 114 directions.

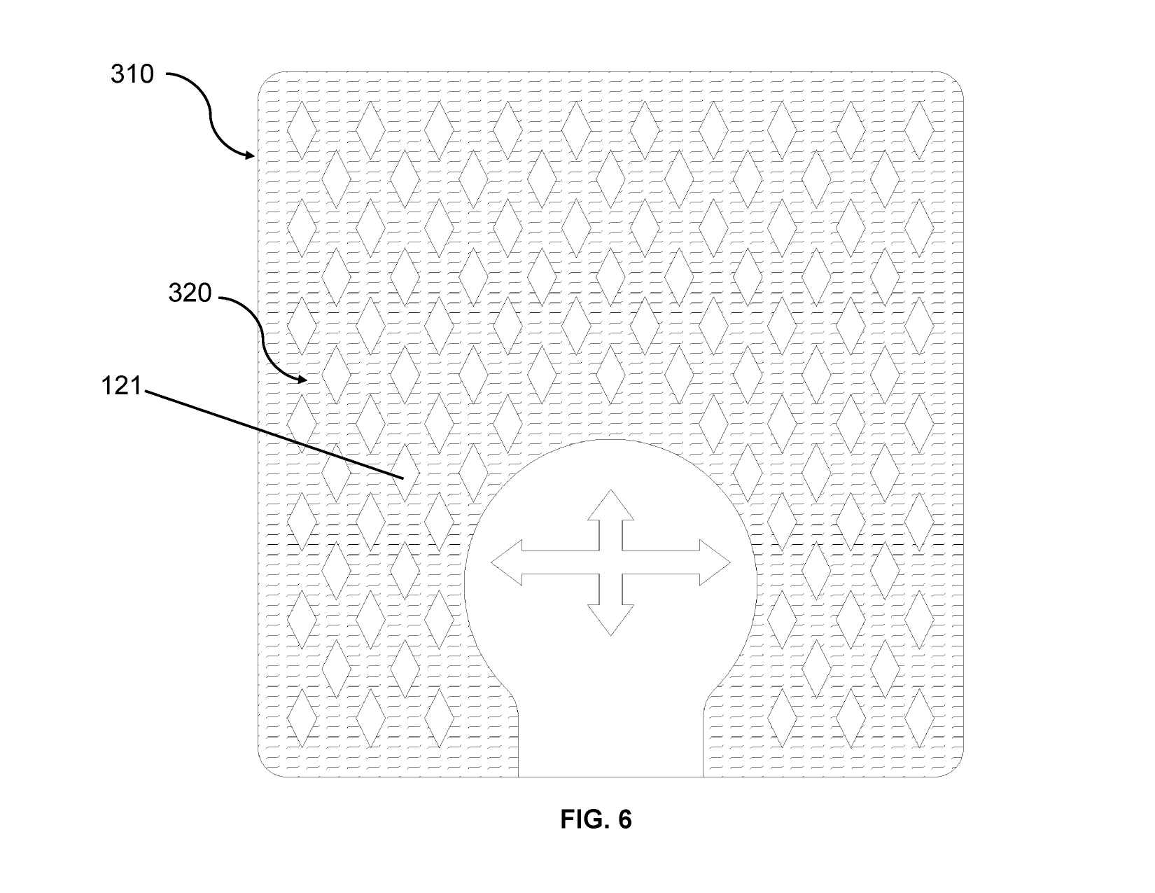

Referring now at FIG. 6, an embodiment of a cover 310 having an anti-slip layer 120 having an opacity of less than 100% of the surface covered with anti-slip layer 120 is illustrated. In such embodiment, the friction effect of the anti-slip surface 120 on the fabric properties may be limited by applying an anti-slip substrate or layer 120 having an opacity or a covering proportion being less than 100%, such as but not limited to between 20% to 90 % of the overall surface being coated 120. To achieve such proportions, the anti-slip layer 120 may comprise portions without anti-slip coating 121. In the illustrated embodiment, the portions without anti-slip coating 121 form a pattern 320 of diamonds or lozenges 121. The said portions with non-friction surfaces shape or empty areas 121 are repeated in the anti-slip area 120, such as but not limited to alternating diamonds. The repeated patterns 320 generally aim at minimizing effects on the stretching properties of the base fabric 122.

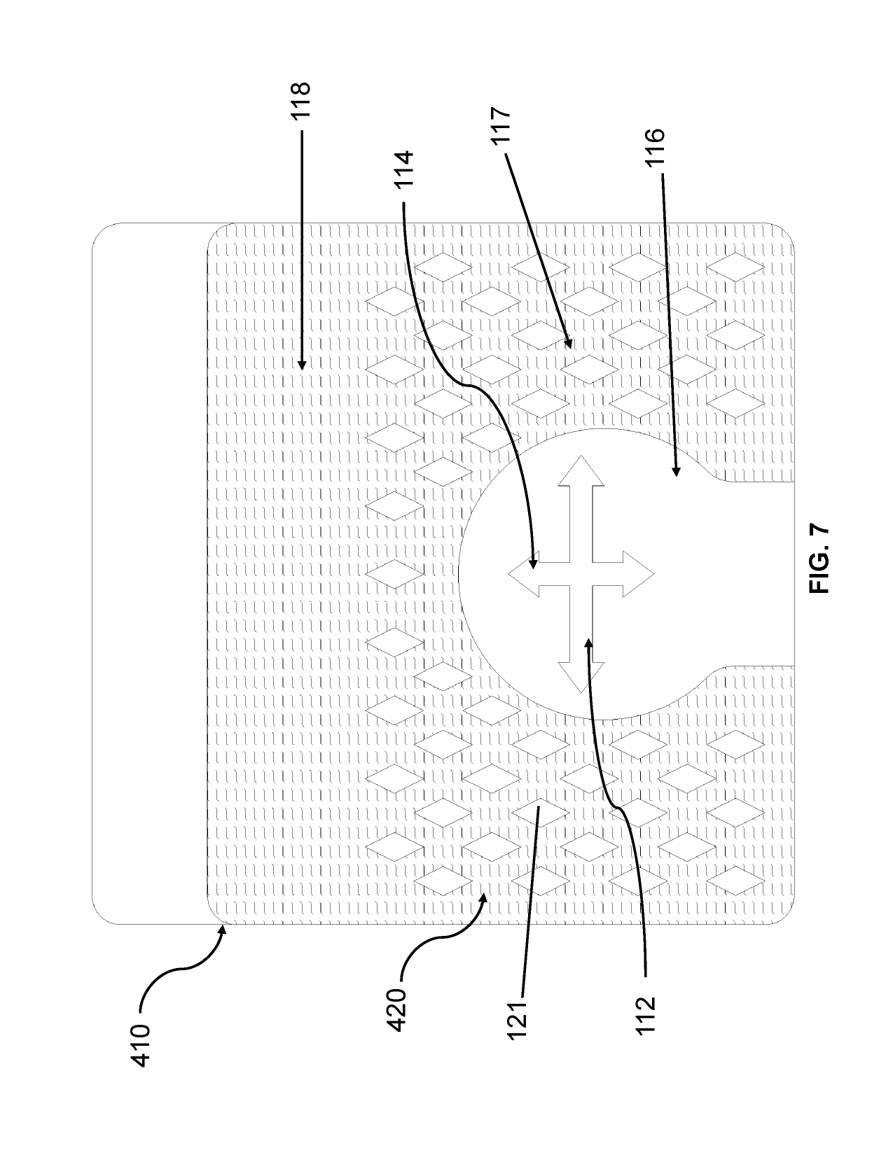

Referring now to FIG. 7, another embodiment of a cover 410 comprising a pattern 420 of diamonds 121 is illustrated. The said pattern 420 comprises non-coated diamonds 121 generally located under ischium / sacrum area of the user 116. As such, the stretch properties in the ischium / sacrum area 116 is maximized, the friction in the gluteal area 117 is increased and the friction in the thigh area 118 is maximized, as the risk of pressure ulcer is low in the thigh area 118.

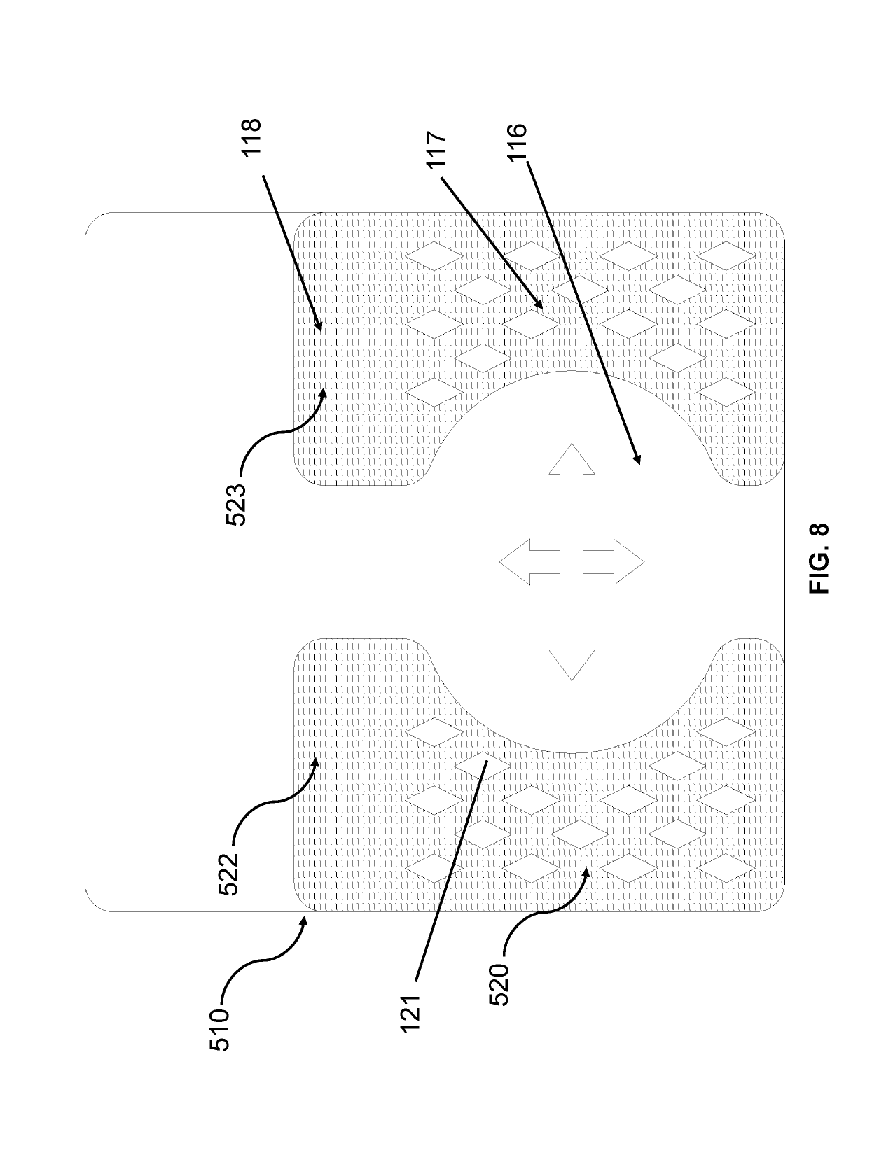

Referring now to FIG. 8, another embodiment of a cover 510 comprising alternate patterns 520 having diamonds 121, similar to the pattern 420 shown in FIG. 7, is illustrated. The pattern of diamonds 520 generally aims at increasing or maintaining stretching properties in the axis of the first stretching direction 112 while reducing or limiting the stretching properties in the axis of the second direction 114. As such, in such design, the ischium / sacrum area 116 remains a low friction area while the buttock area 117 has more friction that the ischium/scrum area 116. Anti-slip coverage in the thigh area 118 is limited for comfort or transferring purpose. In such embodiment 510, the anti-slip layer with pattern 520 does not cover the full area of the top surface of the cover 510 and is divided into a left 522 and right 523 sections.

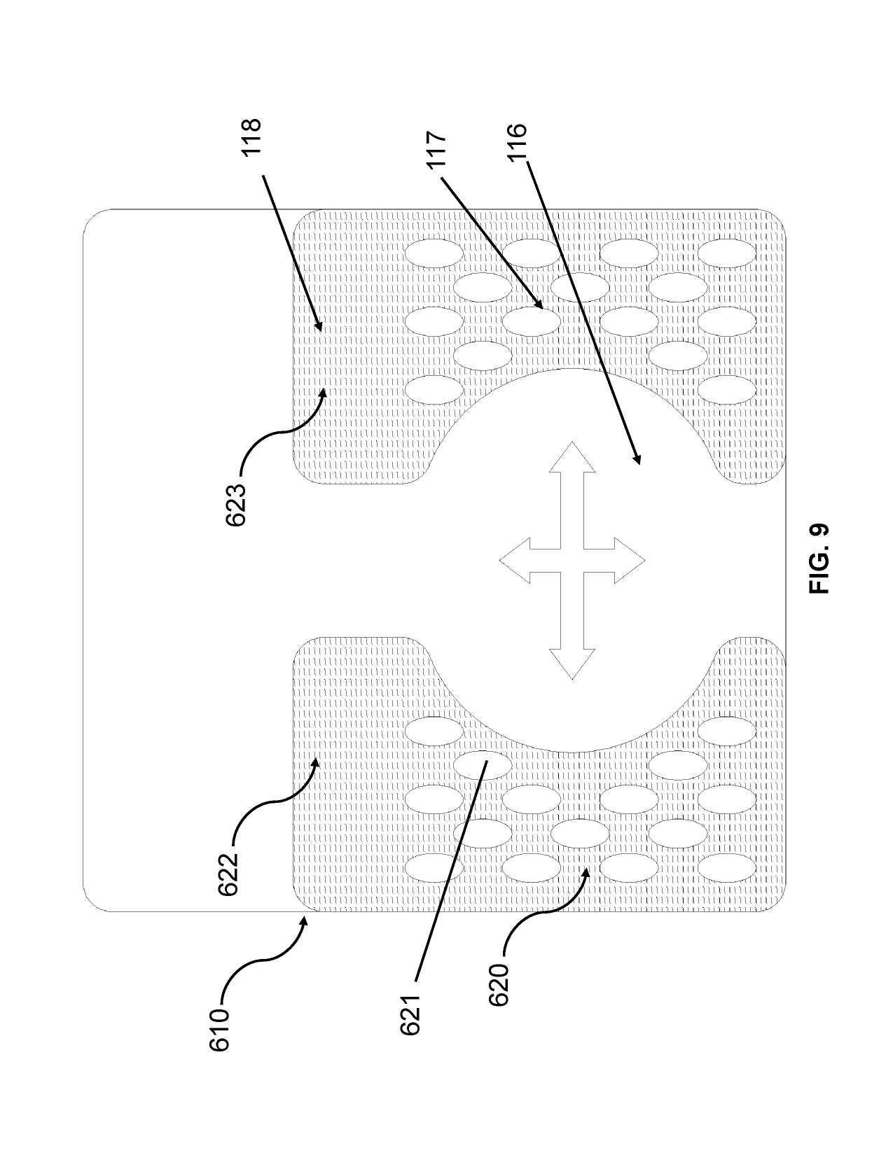

Referring now to FIG. 9, a further embodiment of a cover 610 comprising a pattern 620 comprising alternate elliptical shapes 621 is illustrated. The pattern 620 generally leads to similar properties as patterns 121 and 621 comprising diamond shapes 121 pas shown at FIGS. 7 and 8. The illustrated bare portions or portions 122 not covered with an anti-slip layer 120 and generally extends under the ischium / sacrum area 116 of the user. As such, the bare portion 122 generally aims at preserving the stretching properties of the base material. In such embodiment 610, the anti-slip pattern 621 is not applied on 100% of the top surface of the cover and is divided into a left 622 and right 623 distinct sections.

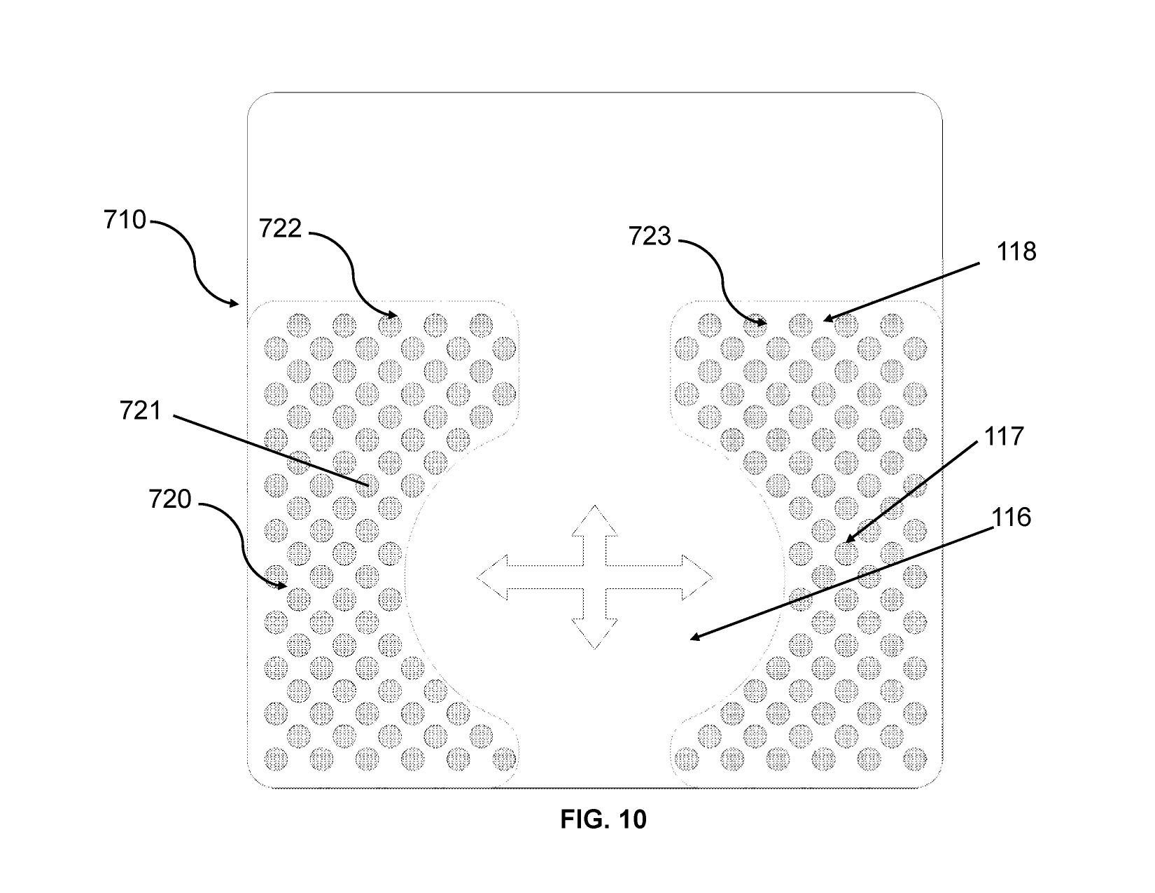

Referring now to FIG. 10, yet another embodiment of a cover 610 comprising an anti-slip layer 120 having a pattern 720 comprising non-oriented dots 721 made of anti-slip material is illustrated. In such embodiment, the dot shapes 721 are coated with anti-slip material and the surrounding area is made of bare or stretchable material. The embodied pattern 720 is typically applied on a two-way stretch fabric. The non-coated area 122 generally aims at preserving the base stretching material properties. In such embodiment 710, the anti-slip pattern 720 does not cover 100% of the top surface of the cover and is divided into a left 722 and right 723 sections.

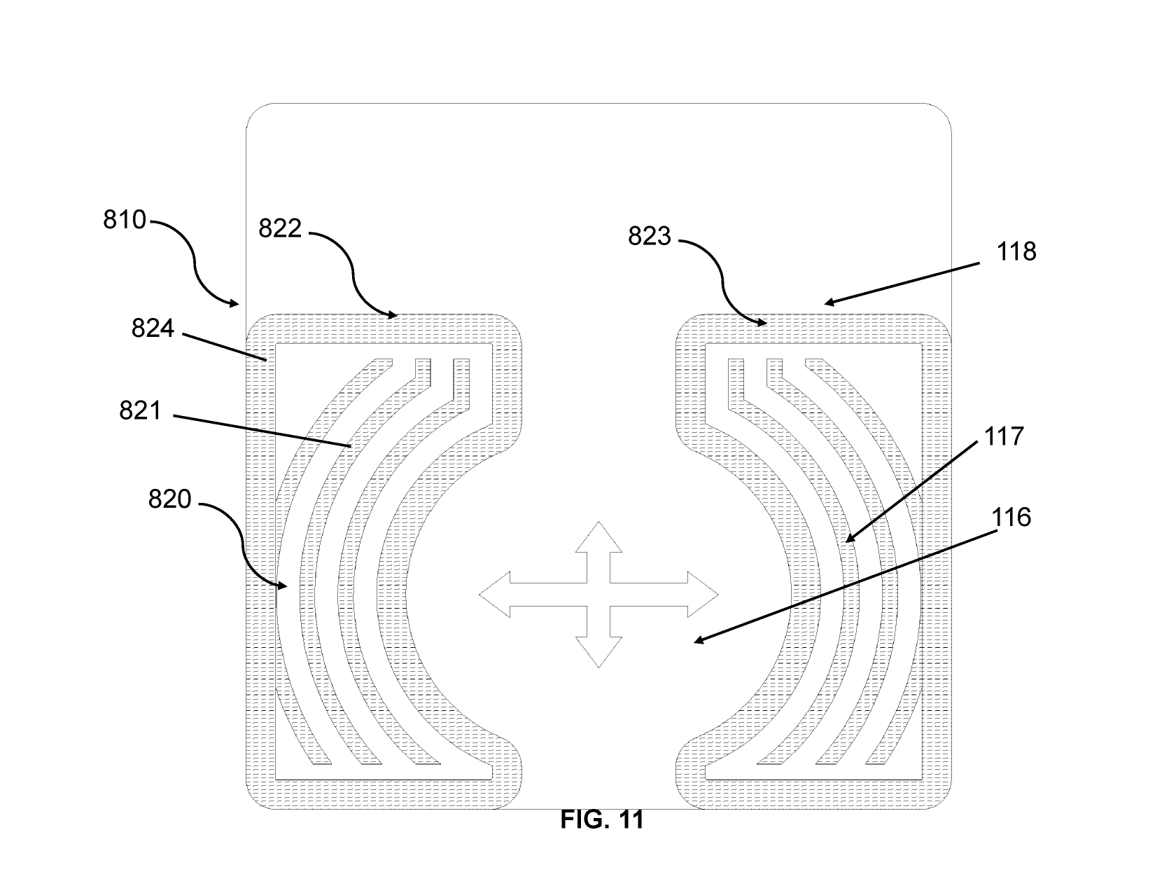

Referring to FIG. 11, an alternative embodiment of a cover 810 comprising a pattern 821 comprising a plurality of curvilinear shapes 821 of anti-slip layer or material 120 is illustrated. The pattern 821 further comprises a contour or surrounding shape 824 surrounding the curvilinear shapes 821. The contour shape 824 generally creates a central stretchable portion 116 for receiving the ischium / sacrum of the user while the limited friction formed by the curvilinear shapes 821 are positioned to form the gluteal area 117. In such embodiment 810, a curvilinear shape 821 coated with the anti-slip layer 120 may also create zone preserving the base stretching properties of the base material similarly to embodiments presented at FIGS. 7-10. In such embodiment 810, the anti-slip pattern 820 does not cover 100% of the top surface of the cover 810 and is divided into a left 822 and right 823 sections.

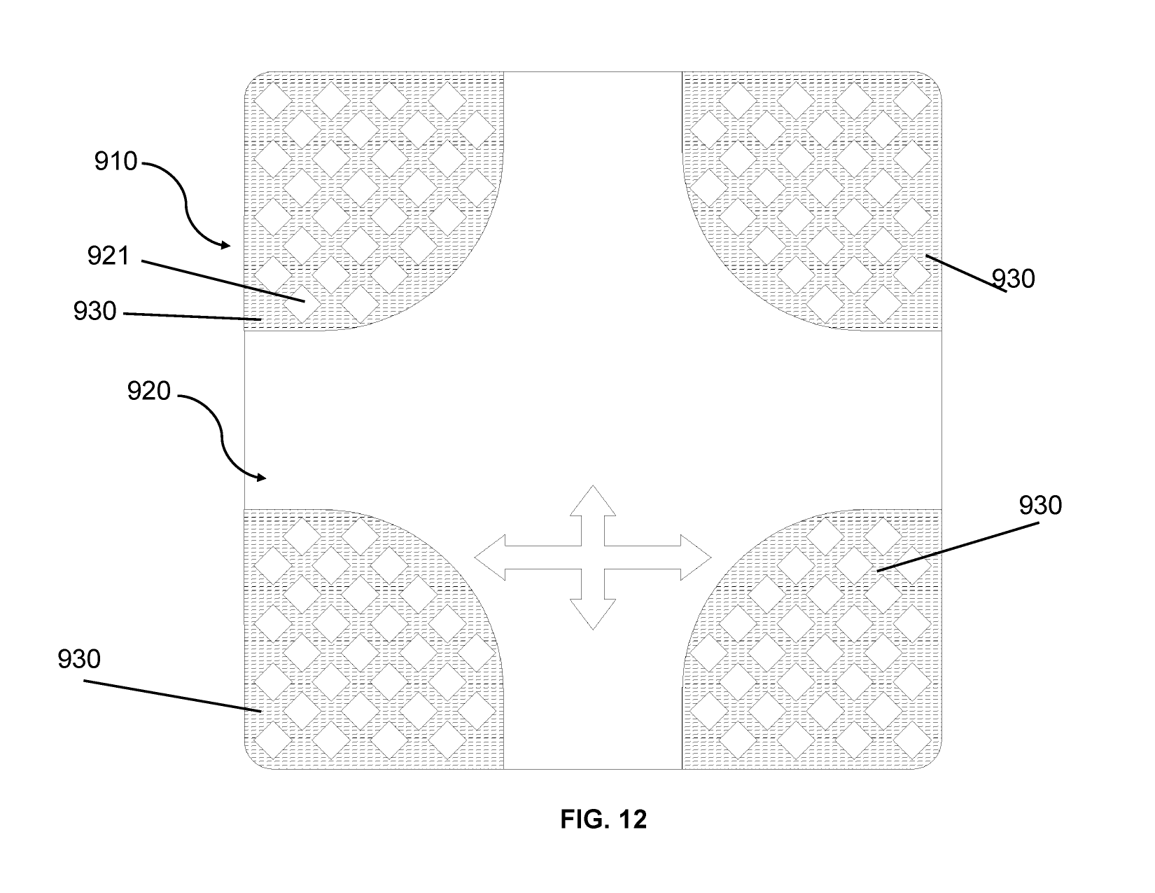

Referring now to FIG. 12, a further embodiment of a cover 910 comprising a pattern 920 of anti-slip layer 120 is illustrated. The pattern 920 comprises four distinct areas 930 having anti-slip properties. The areas 920 are generally positioned for clinical or practical reasons. In such embodiment of the cover 910, the four sections 920 are each located in a corner of the cushion 100 or cover 910, generally ensuring that improper cushion cover orientation does not negatively impact anti-slip properties and provides reduced friction areas for receiving the ischium/sacrum of the patient regardless of the orientation of the cover 710 on the cushion 100 (not shown). As such, the cushion 100 or cover 110 may be positioned in any direction while maintaining substantially similar properties. In the other embodiments, the shape of the forms without anti-slip properties 921 may affect the two-way stretchability of the cover 910, as if a shape creates increased stretchability in the first direction 112 in relation to the second direction 114. In the illustrated embodiment, the square shape of the pattern 920 allow substantially equal friction and/or stretchability in any direction.

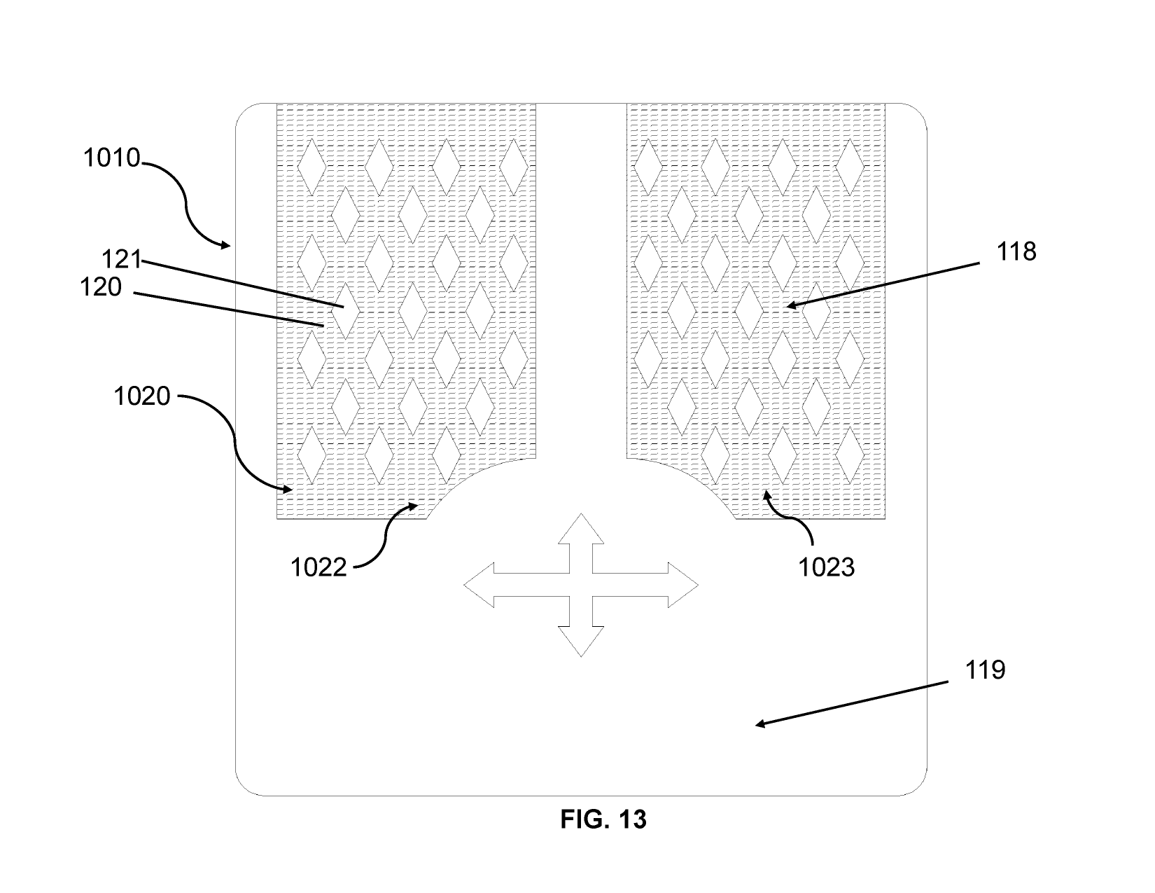

Referring to FIG. 13, an embodiment of a cover 1010 of a cushion 100 comprising an anti-slip layer 120 is illustrated. As illustrated, the cover 1010 comprises two sections 1022 and 1023 having a layer of anti-slip material 120. Such sections 1022 and 1023 represent the area on which is applied an anti-slip coating 120. In such embodiment 1010, the thigh section 118 has about 75% of anti-slip layer 120 and the rear section 119 has no or nearly no coverage. The surface shown without a design pattern does not comprise anti-slip coating to preserve the fabric material properties.

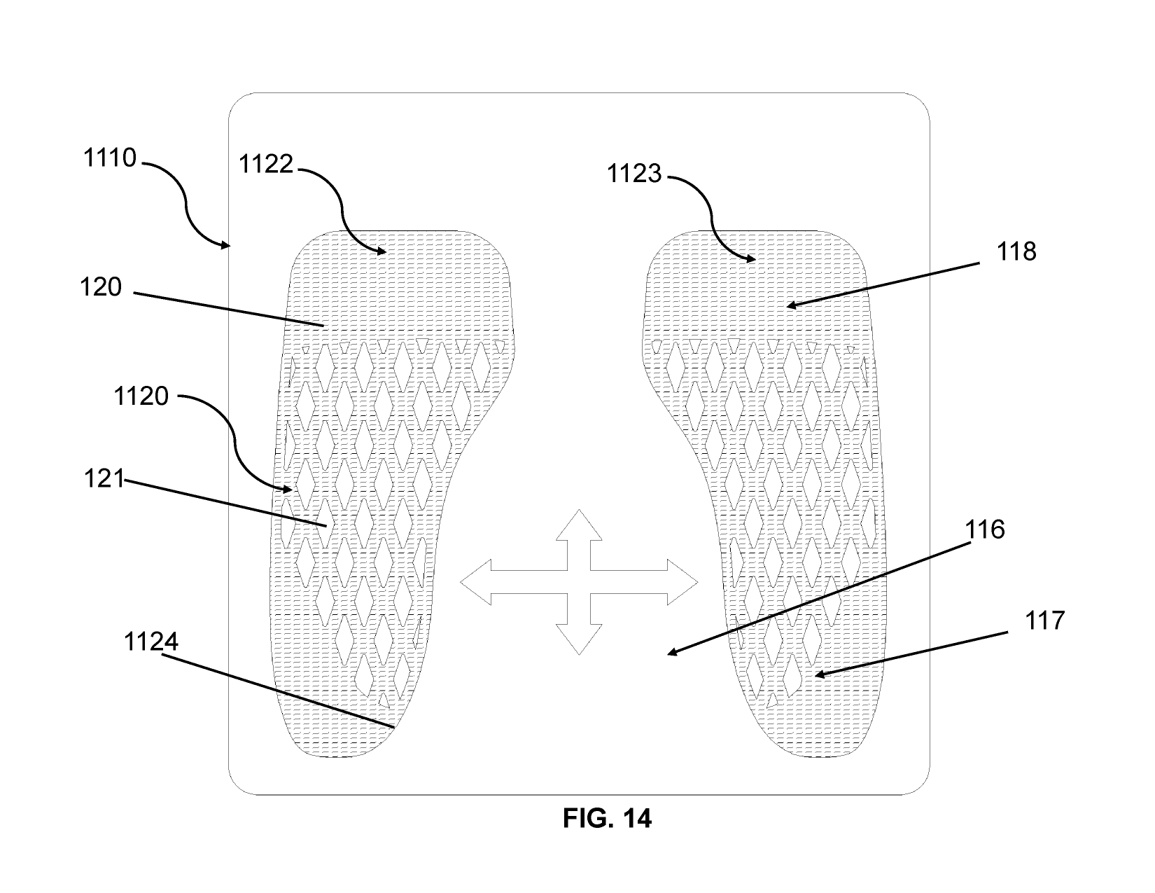

Referring now to FIG. 14, a further embodiment of a cover 1110 comprising a pattern 1120 of anti-slip layer 120 is illustrated. The said pattern 1120 comprises non-coated diamonds 121 generally located at a position for receiving thigh portion 118 and gluteal portion of the user 117. As such, the stretch properties in the ischium / sacrum area 116 is maximized, the friction in the gluteal area 117 is increased over the ischium/sacrum area 116 and the friction in the thigh area 118 is maximized, as the risk of pressure ulcer is low in the thigh area 118. In such embodiment, the anti-slip layer 120 comprises an angled or opened portion 1124 to avoid that the force on a rear portion of the buttocks of the user create a force or tension on the skin located over the ischium of the user when slipping. The opened or enlarged portion 1124 generally has an angle varying between 5 to 10 degrees about a vertical axis. Understandably, while the overall shape of the anti-slip layer 120 is generally rounded in such embodiment, any overall shape may be used according to the specific needs of the patient or user.

Understandably, while the shape of the non-covered section of the different patterns are diamonds, lozenges, elliptic shape or dots, any other shape forming a pattern with or without anti-slip covering may be used within the scope of the present invention, including but not limited to square, rectangular, circular or any other design shapes.

In yet other embodiments, the patterns 120 may be applied directly on a top surface of the cushion 100. In such embodiment, the anti-slip layer 120 is applied directly on the cushion top layer, allowing for increased adhesion between the foam cushion and the cover (not shown) to avoid the positional migration. The coated layer120 may further add friction between the cover and the foam (not shown) to get a better retaining force.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. An anti-slip cover for a therapeutic cushion of a wheelchair comprising:
a base layer configured to cover the therapeutic cushion, the base layer having directional stretching properties; and
a layer of flexible anti-slip material affixed over the base layer and forming patterns configured to retain buttock of a user in a proper therapeutic position;
wherein the formed pattern comprises:
a low friction area positioned to receive ischium/sacrum of the user; an area positioned to receive gluteal portion of the user, the gluteal area having a friction coefficient higher than a friction coefficient of the ischium/sacrum area; and
an area to receive thigh portion of the user having a friction coefficient higher than the friction coefficient of the ischium/sacrum area.

2. The anti-slip cover of claim 1, the anti-slip layer forming an opened portion exposing the base layer to receive a rear portion of the buttocks of the user.

3. The anti-slip cover of claim 2, the opened portion having an angle varying between 5 to 10 degrees about a vertical axis.

4. The anti-slip cover of claim 1, the area to receive thigh portion of the user having a friction coefficient higher than the friction coefficient of the gluteal area.

5. The anti-slip cover of claim 1 that stretches along two different axes.

6. The anti-slip cover of claim 5, the two different axes are orthogonal.

7. The anti-slip cover of claim 6 having higher stretching properties along a first of the two stretching axes than along a second of the two stretching axes.

8. The anti-slip cover of claim 1 wherein the layer of anti-slip material is coated to the base layer.

9. The anti-slip cover of claim 10 wherein the layer of anti-slip material is made of silicone or urethane.

10. The anti-slip cover of claim 1 wherein the base layer is made of low friction and breathable fabric.

11. The anti-slip cover of claim 1 wherein the formed patterns of the anti-slip layer comprise shapes exposing the base layer.

12. The anti-slip cover of claim 11, the patterns being shaped as any one of elliptical, diamond, dot, lozenges or curvilinear shapes.

13. The anti-slip cover of claim 1 wherein the formed patterns comprises shapes of anti-slip material over the base layer.

14. The anti-slip cover of claim 1, the layer of anti-slip material covering less than 100% of the base layer.

15. The anti-slip cover of claim 14, the layer of anti-slip material covering between 20% and 90% of the base layer.

16. A method for manufacturing an anti-slip cover for a therapeutic cushion comprising:
having a base layer shaped to be received by a top portion of the therapeutic cushion, the base layer having directional stretching properties; and
adding a layer made of flexible anti-slip material on the base layer to form ant-slip patterns configured to retain buttock of a user in a proper therapeutic position, the formed pattern comprising:
a low friction area positioned to receive ischium/sacrum of the user;
an area positioned to receive gluteal portion of the user, the gluteal area having a friction coefficient over higher than a friction coefficient of the ischium/sacrum area; and
an area to receive thigh portion of the user having a friction coefficient over higher than the friction coefficient of the ischium/sacrum area.

17. The method in claim 16 wherein the creation of pattern of the anti-slip material uses a silk screen process.
